(19) United States
(12) Patent Application Publication
(10) Pub. No.: US 2019/0140324 A1
(43) Pub. Date: May 9, 2019

(54) BATTERY CHARGING METHOD

(71) Applicant: Sunforge LLC, Somerville, MA (US)

(72) Inventor: Alex C.H. MEVAY, Cambridge, MA (US)

(21) Appl. No.: 15/803,150

(22) Filed: Nov. 3, 2017

(51) Int. Cl. H01M 10/44; H02J 7/00

(52) U.S. Cl. CPC H01M 10/44; H02J 7/008

(57) ABSTRACT

A method for charging batteries constructed from Lithium cells, the method including a substantially monotonically increasing time-varying voltage phase interposed between conventional constant current (CC) and constant voltage (CV) phases. Advantageously, methods according to the present disclosure provide rapid charging of Lithium batteries without negatively affecting their service lifetime(s). More specifically—and in sharp contrast to prior art methods—methods according to the present disclosure: (a) provide charging of Lithium batteries such that peak cell voltages are reduced; (b) do not appreciably increase charging time; (c) may be readily and inexpensively implemented in a charger; and (d) do not require communication with a Battery Management System or measurement of individual cell voltages.

### TECHNICAL FIELD

This disclosure relates generally to a battery charging method. More particularly, it pertains to a method for charging lithium ion batteries including a substantially monotonically increasing time-varying voltage phase in addition to conventional constant current (CC) and constant voltage (CV) phases.

### BACKGROUND

As will be readily appreciated by those skilled in the art, the process by which a battery is charged may determine both the relative usable capacity of that battery and to a large degree the service life that can be expected from the battery. This is particularly true for Lithium cells which—if charged in overvoltage conditions—may experience a significant shortening of service life.

Importantly, batteries employing such Lithium cells are now used in many applications including consumer electronics devices due—in part—to their high capacities, lighter weight and higher discharge rates.

Given their importance in such contemporary devices and applications, improved methods of charging Lithium cells and batteries constructed therefrom would represent a welcome addition to the art.

### SUMMARY

An advance is made in the art according to aspects of the present disclosure directed to a method for charging batteries constructed from Lithium cells. In sharp contrast to the prior art, the method according to the present disclosure includes a substantially monotonically increasing time-varying voltage phase interposed between conventional constant current (CC) and constant voltage (CV) phases.

Advantageously, methods according to the present disclosure provide rapid charging of Lithium batteries without negatively affecting their service lifetime(s). More specifically—and in sharp contrast to prior art methods—methods according to the present disclosure: (a) provide charging of Lithium batteries such that peak cell voltages are reduced; (b) do not appreciably increase charging time; (c) may be readily and inexpensively implemented in a charger; and (d) do not require communication with a Battery Management System or measurement of individual cell voltages.

This SUMMARY is provided to briefly identify some aspect(s) of the present disclosure that are further described below in the DESCRIPTION. This SUMMARY is not intended to identify key or essential features of the present disclosure nor is it intended to limit the scope of any claims.

The term “aspect” is to be read as “at least one aspect”. The aspects described above and other aspects of the present disclosure are illustrated by way of example(s) and not limited in the accompanying drawing.

### BRIEF DESCRIPTION OF THE DRAWING

A more complete understanding of the present disclosure may be realized by reference to the accompanying drawing in which:

FIG. 1 shows a plot depicting illustrative, prior art, Lithium battery charging highlighting different charging phases;

FIG. 2 shows a plot depicting illustrative, prior art, multi-stage battery charging highlighting different charging phases;

FIG. 3 shows plot of applied voltage per cell vs. time for a CC/CV method depicting illustrative, prior art Lithium battery charging;

FIG. 4 shows a plot of voltages of the cells within a battery vs. time for a CC/CV method depicting illustrative, prior art Lithium battery charging;

FIG. 5 shows a plot of applied voltage per cell vs. time for Lithium battery charging according to aspects of the present disclosure;

FIG. 6 shows a plot of voltages of the cells within a battery vs. time for Lithium battery charging according to aspects of the present disclosure;

FIG. 7 is a flow diagram illustrating a method according to aspects of the present disclosure; and

FIG. 8 is a schematic of an illustrative computer system on which methods according to the present disclosure may be executed.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not been shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure.

In addition, it will be appreciated by those skilled in art that any flow charts, flow diagrams, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

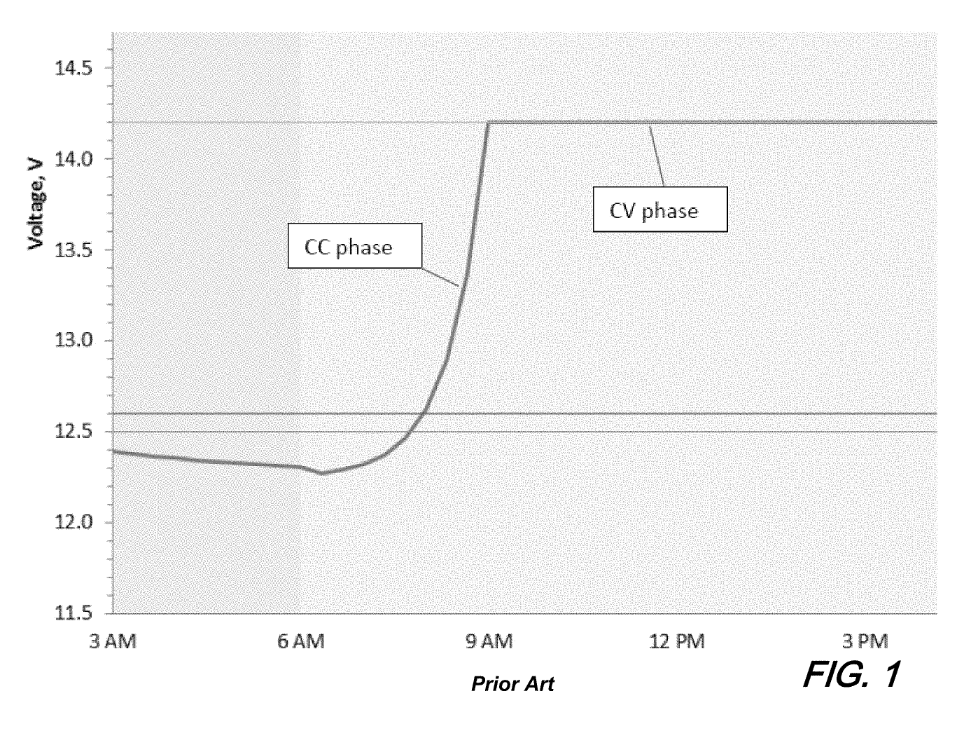

By way of some additional background, we begin by noting that contemporary Lithium batteries are typically charged according to known constant-current/constant-voltage (CC/CV) methods. With reference to FIG. 1—which shows a plot illustrative of such a CC/CV method during the charging of a Lithium battery by a representative battery charger—it may be observed that the battery is initially charged by applying a constant-current (CC phase) and then later by applying a constant-voltage (CV phase). Note that if charging is performed using solar or other variable power sources, a maximum current that the particular source is capable of supplying may define the applied current.

During that initial constant current phase, the battery voltage increases up to a predetermined, “constant voltage” point set in the charger. When the battery reaches that constant-voltage point, the charger reduces the current to maintain that constant voltage. In a typical charging operation, the constant voltage is maintained indefinitely, until either the battery is removed from the charger (as in consumer devices) or the power input is no longer sufficient to maintain the constant voltage (i.e., a solar powered system supporting multiple loads).

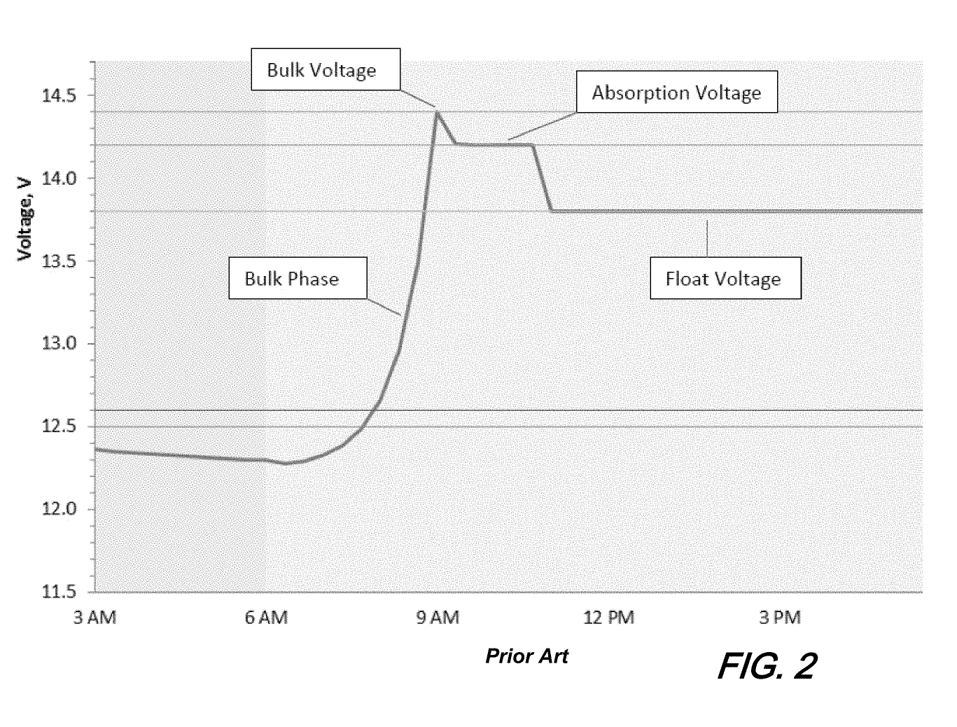

Turning now to FIG. 2, there is shown a plot of a prior art, “multi-stage” charging method—historically employed in lead-based batteries—now finding increasing application for Lithium Iron Phosphate batteries. As known by those skilled in the art, such multi-stage charging was developed to provide full charges to batteries while extending battery lifetime(s) by avoiding prolonged periods of high voltage(s). As may be observed by inspection of FIG. 2, the multi-stage charging method includes an initial, constant-current phase—also known as a “bulk phase”—which is performed and charges the battery until the battery reaches a “bulk voltage”. Upon reaching this bulk voltage, a battery charger will reduce the current to maintain an absorption voltage—which may be equal to or less than the bulk voltage. The absorption voltage is then maintained for either a set time (e.g., 0.25-3 hours), or until the net battery current drops below some threshold. When the time expires or the net current drops below the threshold value, the charger maintains a lower “float voltage”—analogous to the CV phase of CC/CV charging—which period brings the battery all the way through and maintains a substantially 100% state of charge. The current will also decrease to a point where it is considered a “trickle” and maintains this float stage where there is a continuing charge applied to the battery at all times, but at a safe rate to ensure a full state of charge. Most contemporary battery chargers do not turn off during the float stage as it is safe to continuously maintain the float voltage for an extended period of time—i.e., months or even years.

With this background in place it is noted that CC/CV charging is generally favored for Lithium cell batteries due to its simple implementation while multi-stage charging advantageously balances conflicting needs of full charges and long battery lifetime(s). Notwithstanding such advantages, both methods exhibit significant infirmities when applied to multi-cell Lithium batteries.

As is known, contemporary Lithium cell batteries often include multiple, individual Lithium cells connected in series to provide a higher operating voltage than a single cell. And while the multiple cells of a single battery are the same type and capacity, even cells originating from a same manufacturing run may exhibit variations in capacity and coulombic efficiency.

Accordingly, due to such normal variations, individual cells within a single battery pack may drift to different states of charge (SoC). By way of illustrative example only—in a 2-cell battery—one cell may be at 50% SoC and the other may be at 60% SoC. Charging such a battery must be stopped when the one (high) cell reaches 100% SoC—even though the other (low) cell is only at 90% SoC. Conversely, if the battery is subsequently discharged, the discharge must be stopped when the low cell reaches 0% SoC—meaning that only 90% of the battery capacity is available even though each cell is individually capable of delivering its full capacity.

As will be understood and appreciated by those skilled in the art, batteries may include a balancing mechanism for correcting such normal drifts in cell state-of-charge. For example, Lead-acid batteries employ aqueous sulfuric acid electrolyte. When Lead-acid batteries are charged—and a particular cell reaches 100% SoC—charging will continue and the 100% SoC cell—rather than storing additional energy—begins to dissipate additional charge by electrolyzing the electrolyte into Hydrogen gas (H₂) and Oxygen gas (O₂) which in turn is vented or recombined into water (H₂O). Since a current remains applied to any high cell(s) (100% SoC), any lower cell(s) (<100% SoC) can continue charging until they too reach 100% SoC, thereby ensuring a complete, full charge of the battery. This “passive balancing” typically occurs during an Absorption phase of multi-stage charging. In some applications, a controlled overcharge known as “Equalization” is periodically applied to facilitate the balancing.

Unlike Lead-based batteries however, Lithium batteries do not have such an intrinsic, passive mechanism to dissipate excess charge. Of course, such a characteristic is both advantageous and disadvantageous. Advantageous in the sense that, because Lithium batteries do not exhibit a significant coulombic loss mechanism, they are much more efficient as measured by the amount of energy output relative to the amount of energy input. Disadvantageous because Lithium cells must still be kept in balance and such balancing must be provided by an external electrical apparatus generally known as a Battery Management System (BMS).

Note that the balancing capability of a BMS—which may be quantified by the amount of current the balancing process is able to divert, shunt, or otherwise manage—is typically less than that for a Lead-based battery because the Lead battery may dissipate excess charge as heat throughout its large mass and volume of the cell(s) or release the charge energy as vented Hydrogen and Oxygen gas(es). Conversely, a BMS is typically a small(er) accessory to the battery cells and has comparatively limited capability for heat dissipation. As will be readily appreciated by those skilled in the art, if a BMS cannot balance the cells quickly enough, it may need to disable charging while balancing occurs. Those skilled in the art will immediately recognize and appreciate that if charging is disabled during such balancing, applications requiring continuous power output my not be served

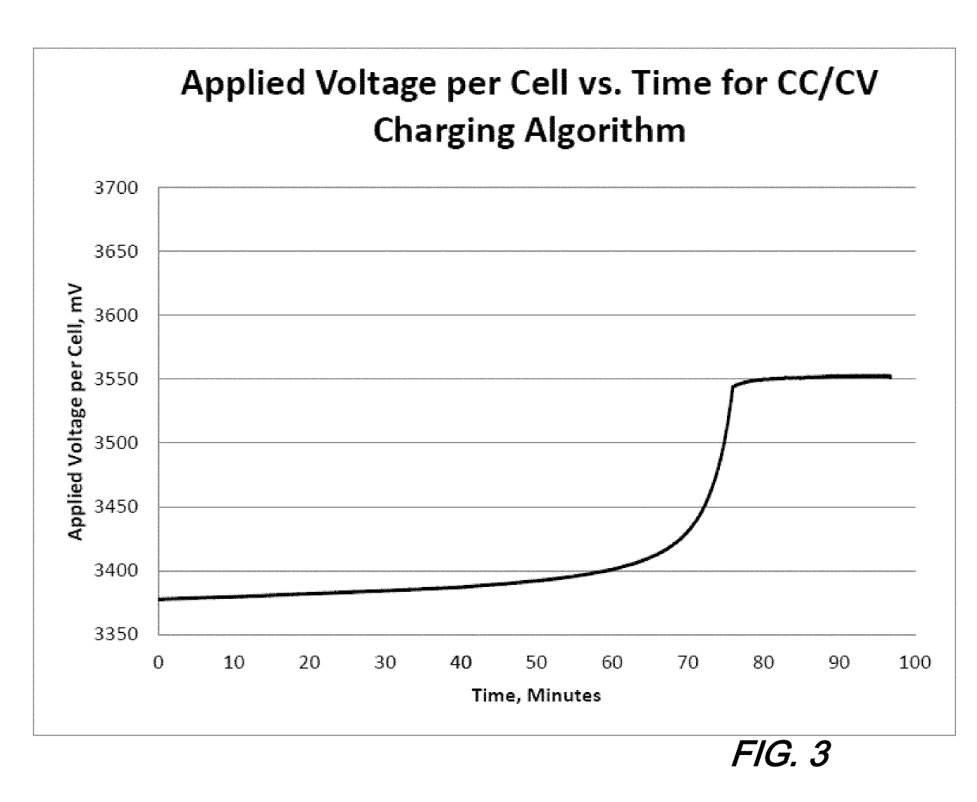

Turning now to FIG. 3, there is shown a plot of applied voltage per cell vs. time for a prior art CC/CV charging method as known in the prior art. There, it may be observed a constant-current phase (until about 72 minutes) is experienced until a constant-voltage phase (from 72 minutes onward) is maintained. Note that the latter portion of the constant-current phase is characterized by a continuously increasing slope until the constant-voltage phase is reached. Note further that the constant-voltage phase voltage is not completely constant due to wiring resistance between a charger and the battery.

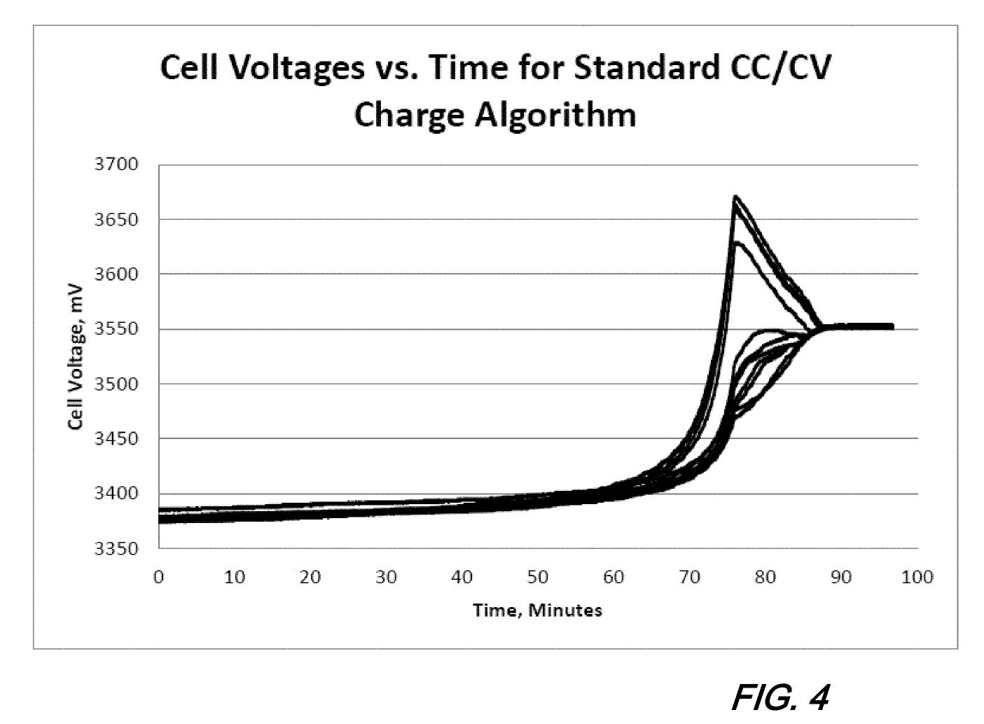

FIG. 4 is a plot of voltages of the cells within a battery vs. time for a prior art CC/CV charging method. From this plot one may observe that while the average of the cell voltages is equal to applied voltage per cell, there is a significant variation between cells as the battery pack is charged. In the example shown in this figure, the Battery Management System begins balancing when the highest cell exceeds 3520 mV. Even though the nominal maximum cell voltage is 3550 mV per cell, some of the cells reach as high as 3670 mV during charging. This high cell voltage reduces cell (and therefore battery pack) lifetime, and decreases safety of the battery pack as a result of increased cell reactivity during the high voltage excursions.

As a result—in some charging systems—the BMS communicates with the charger to limit voltage or current if cell voltages rise too high. Such an approach increases overall system cost and complexity and may not even be possible in some applications as the communication protocols employed may be manufacturer-specific.

Advantageously, methods according to the present disclosure provide charging of Lithium batteries such that peak cell voltages are reduced, do not appreciably increase charging time, may be readily and inexpensively implemented in a charger, and do not require communication with a Battery Management System or measurement of individual cell voltage(s).

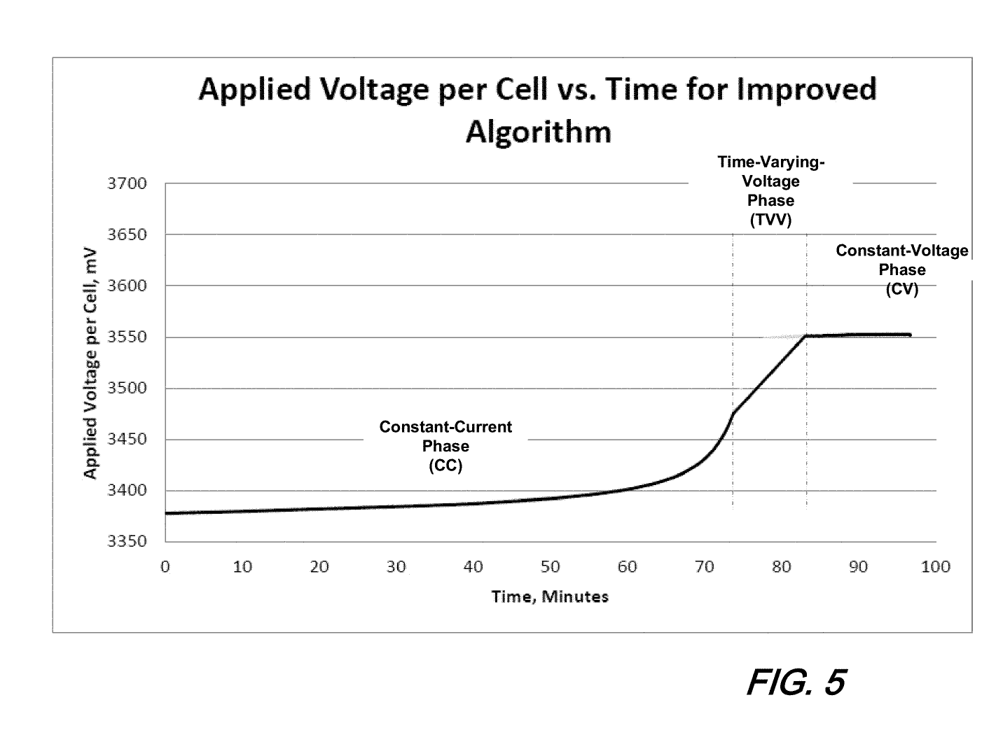

Turning now to FIG. 5, there is shown a plot of applied voltage per cell vs. time of a Lithium cell charging according to aspects of the present disclosure. As may be observed from that figure, methods according to the present disclosure include a time-varying-voltage (TVV) charging phase—in addition to and interposed between constant-current (CV) and constant-voltage (CV) phases of charging.

At this point we note that since the above-noted deleterious cell voltages generally occur at or near a transition from Bulk to Float (or CV) in a CC/CV method, methods according to the present disclosure “soften” this transition and provide a BMS more time to balance while also providing sufficient voltage(s) for balancing to function effectively. We note further that in sharp contrast to the prior art CC/CV or multi-stage methods which charge as quickly as possible to the highest voltage attained, methods according to the present disclosure first charge to a lower bulk voltage and then monotonically increase the voltage—slowly, over time—to the highest voltage attained.

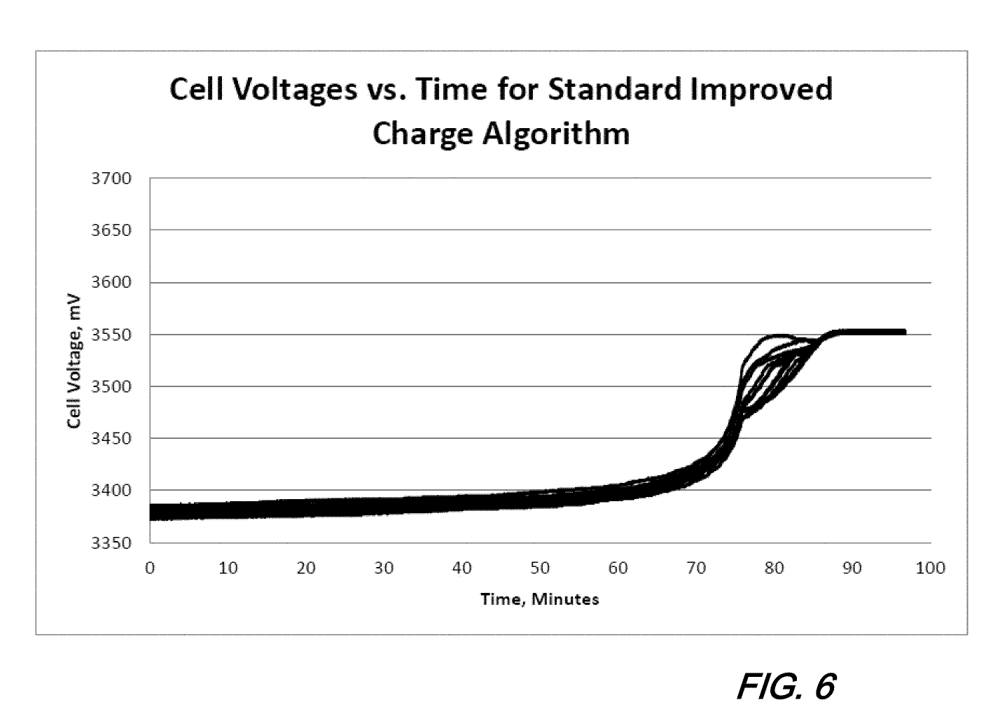

As may be observed from FIG. 6—which shows a plot of voltages vs. time of the Lithium cell(s) within a battery charging according to aspects of the present disclosure—that such methods according to the present disclosure only require a minimal increase in charging time over the prior art methods. Importantly, the figure also shows that this charging is performed while exhibiting a significant reduction in maximum cell voltages.

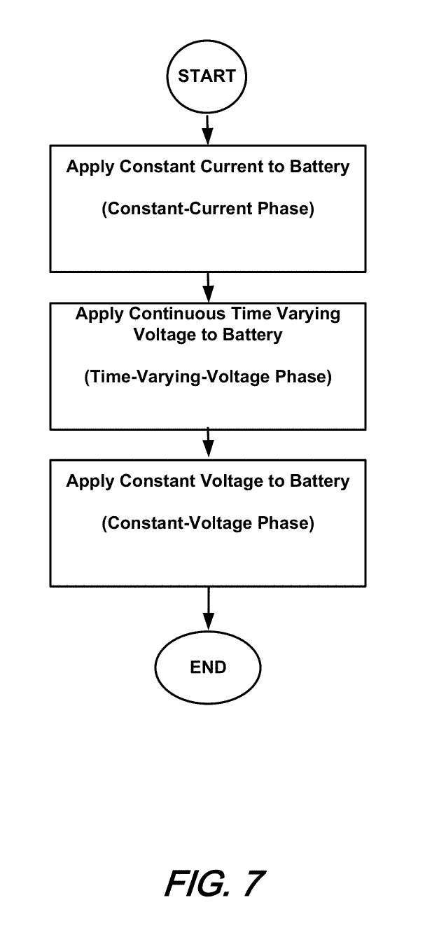

FIG. 7 is a flow diagram depicting an overview of battery charging method(s) according to aspects of the present disclosure. As may be generally observed from that diagram, methods according to the present disclosure include three consecutive charging phases—or stages—namely, a constant-current phase, followed by a time-varying-voltage phase (TVV), which in turn is followed by a constant-voltage (CV) phase.

While not purely apparent from the figures, we note that the TVV phase is a period when the voltage is changing with time, preferably monotonically increasing. By way of illustrative example only, such TVV phase may be described by the relationship y=mx+b, Those skilled in the art will appreciate that other functions may describe this TVV phase as well, so long as it is a substantially monotonically increasing function. This TVV phase will begin—after a CC phase—when the applied voltage reaches a first voltage and proceeds according to a pre-set function (curve). Note that this increasing pre-set function of the TVV phase may be either absolute or relative to the first voltage. Note also that the first voltage reached indicating transition to TVV phase may be reached at a pre-determined value, for example substantially 90% of the battery capacity.

We note further that this TVV phase follows the CC phase in which a charger regulates the current applied to the battery wherein that applied current may be advantageously based on another constraint or specified by the battery undergoing charging.

Subsequent to the TVV phase, a CV phase follows in which the voltage applied to the battery is set by the charger. In common application, the voltage applied is constant.

At this point we note that while the three phases are shown and described as consecutive to one another, those skilled in the art will readily appreciate that one or more intervening phase(s) are possible.

Generally, the first voltage is pre-set, but may be adjusted as a function of other considerations—including the measured temperature of the battery. The TVV phase likewise may end at a pre-set period of time after the first voltage is reached, or end when the applied voltage reaches a second, pre-determined voltage. As with the first voltage, the second voltage may be either pre-set, or adjusted according to other factors including the battery temperature. Note that in addition to being described by a monotonically increasing function, it is notable that the overall charging operation—all three phases—is substantially continuous—including the TVV phase. Accordingly, methods according to the present disclosure are perfectly suited for computer implementation—along with other known circuitry and elements.

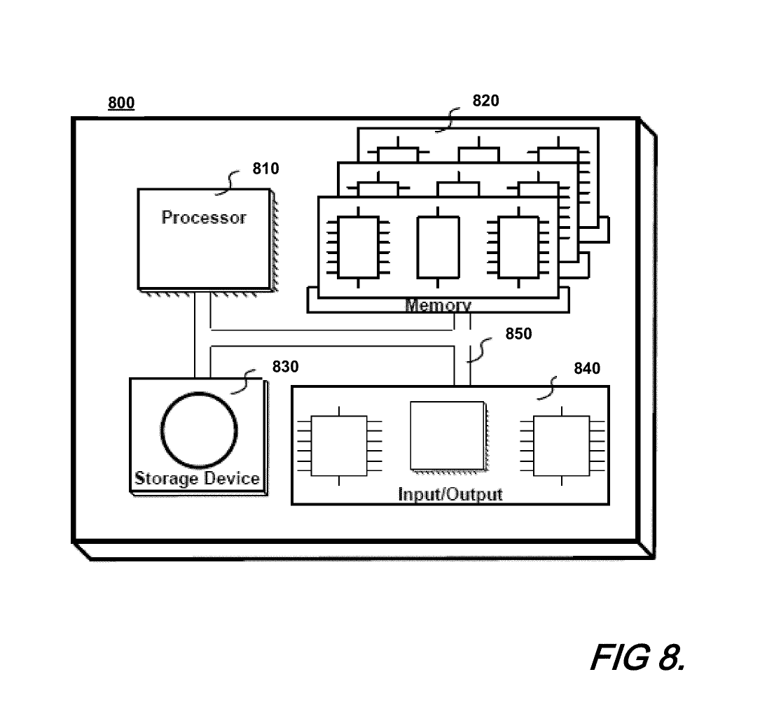

Finally, FIG. 8 shows an illustrative computer system 800 suitable for implementing methods and incorporation into systems according to an aspect of the present disclosure. As may be immediately appreciated, such a computer system may be integrated into another system and may be implemented via discrete elements or one or more integrated components. The computer system may comprise, for example a computer running any of a number of operating systems and/or application programs for performing methods according to the present disclosure. The above-described methods of the present disclosure may be implemented on the computer system 800 as stored program control instructions.

As may be observed, computer system 800 includes processor 810, memory 820, storage device 830, and input/output structure 840. One or more busses 850 typically interconnect the components, 810, 820, 830, and 840. Processor 810 may be a single or multi core.

Processor 810 executes instructions in which embodiments of the present disclosure may comprise steps described previously and/or outlined in one or more of the Drawing figures. Such instructions may be stored in memory 820 or storage device 830. Data and/or information may be received and output using one or more input/output devices.

Memory 820 may store data and may be a computer-readable medium, such as volatile or non-volatile memory. Storage device 830 may provide storage for system 800 including for example, the previously described methods. In various aspects, storage device 530 may be a flash memory device, or other known storage and/or recording technologies.

At this point, those skilled in the art will readily appreciate that while the methods, techniques and structures according to the present disclosure have been described with respect to particular implementations and/or embodiments, those skilled in the art will recognize that the disclosure is not so limited. Accordingly, the scope of the disclosure should only be limited by the claims appended hereto.

1. A battery charging method comprising:
at least three charging phases including:
a constant-current (CC) phase;
a time-varying-voltage (TVV) phase following the CC phase; and
a constant-voltage (CV) phase following the TVV phase.

2. The battery charging method of claim 1 wherein the TVV phase is initiated when the applied voltage reaches a pre-determined first voltage.

3. The battery charging method of claim 2 wherein the pre-determined first voltage is adjusted as a function of battery temperature.

4. The battery charging method of claim 2 wherein the applied voltage changes in a monotonically increasing manner.

5. The battery charging method of claim 4 wherein during the TVV phase an applied voltage continuously changes with time.

6. The battery charging method of claim 4 wherein the TVV phase proceeds according to a pre-determined function relative to a voltage selected from the group consisting of the first voltage and an absolute voltage.

7. The battery charging method of claim 1 wherein during the CC phase the current applied to the battery is regulated by a method selected from the group consisting of: constant current, maximum current, and current specified by a battery being charged.

8. The battery charging method of claim 1 wherein during the CV phase the voltage applied to the battery is regulated to remain constant.

9. The battery charging method of claim 2 wherein the TVV phase ends upon one of the following: after a pre-determined duration, or an applied voltage reaches a second voltage.

10. A battery charging device comprising:
a lithium ion battery; and
a charging controller configured to control charging of the lithium ion battery using the lithium ion charging method according to claim 1.

11. A non-transitory computer storage medium having computer executable instructions which when executed by a computer cause the computer to perform operations comprising:
applying to a battery at least three charging phases including:
a constant-current (CC) phase;
a time-varying-voltage (TVV) phase following the CC phase; and
a constant-voltage (CV) phase following the TVV phase.

12. The non-transitory computer storage medium according to claim 11 having computer executable instructions which when executed by a computer cause the computer to perform operations comprising: applying to the battery the TVV phase wherein the TVV phase is initiated when the applied voltage reaches a pre-determined first voltage.

13. The non-transitory computer storage medium according to claim 12 having computer executable instructions which when executed by a computer cause the computer to perform operations comprising: applying to the battery the TVV phase wherein the pre-determined first voltage is adjusted as a function of battery temperature

14. The non-transitory computer storage medium according to claim 12 having computer executable instructions which when executed by a computer cause the computer to perform operations comprising: applying to the battery the TVV phase wherein the applied voltage changes in a monotonically increasing manner.

15. The non-transitory computer storage medium according to claim 14 having computer executable instructions which when executed by a computer cause the computer to perform operations comprising: applying to the battery the TVV phase having an applied voltage that continuously changes with time.

16. The non-transitory computer storage medium according to claim 14 having computer executable instructions which when executed by a computer cause the computer to perform operations comprising: applying to the battery the TVV phase wherein the TVV phase proceeds according to a pre-determined function relative to a voltage selected from the group consisting of the first voltage and an absolute voltage.

17. The non-transitory computer storage medium according to claim 11 having computer executable instructions which when executed by the computer cause the computer to perform operations comprising: applying to the battery the CC phase wherein the current applied to the battery is regulated by a method selected from the group consisting of:
constant current, maximum current, and current specified by a battery being charged.

18. The non-transitory computer storage medium according to claim 11 having computer executable instructions which when executed by the computer cause the computer to perform operations comprising: applying to the battery the CV phase wherein during the CV phase the voltage applied to the battery is regulated to remain constant.

19. The non-transitory computer storage medium according to claim 12 which when executed by the computer cause the computer to perform operations comprising: ending the TVV phase upon the occurrence of one of the following: after a pre-determined duration, or an applied voltage reaches a second voltage.

20. The battery charging method of claim 1 wherein the at least three charging phases are consecutive.

21. The battery charging method of claim 2 wherein the pre-determined first voltage is substantially 90% of the battery capacity.

22. The non-transitory computer storage medium of claim 11 wherein the at least three charging phases are consecutive.

23. The non-transitory computer storage medium of claim 12 wherein the pre-determined first voltage is substantially 90% of the battery capacity.
